(19) United States
(12) Patent Application Publication
(10) Pub. No.: US 2023/0169621 A1
(43) Pub. Date: Jun. 1, 2023

(54) COMPUTE SHADER WITH LOAD TILE

(71) Applicant: Huawei Technologies Co., Ltd., Shenzhen (CN)

(72) Inventors: Jiajin TU, Shanghai (CN); Zhenghong PENG, Shanghai (CN)

(21) Appl. No.: 17/540,028

(22) Filed: Dec. 1, 2021

(51) Int. Cl. G06T 1/20; G06T 1/60

(52) U.S. Cl. CPC G06T 1/20; G06T 1/60

(57) ABSTRACT

A method for processing a data workload is disclosed herein. The data workload includes related segments of data. A processor loads a segment of data to a buffer in an on-chip memory of the processor. The buffer is used for temporarily storing one or more segments of the data workload. The processor receives a trigger signal for the segment of data. The trigger signal is generated in response to the segment of data being loaded to the buffer. The processor instantiates a compute shader in response to the trigger signal. The processor loads the segment of data from the buffer to the compute shader for execution by the compute shader.

### TECHNICAL FIELD

This disclosure relates generally to computing technologies, and more specifically to accessibility of on-chip memory of a processor by a compute shader.

### BACKGROUND

Central processing unit (CPU) and graphics processing unit (GPU) play significant roles in nowadays computing technologies. Architecturally, a CPU is composed of several cores with lots of cache memory, and is optimized for serial processing. In contrast, a GPU is composed of hundreds of cores that can handle thousands of threads simultaneously, and is optimized for parallel processing.

From an operational perspective, a CPU processes various functions therein in a same way. For example, functions can access resources at any memory location without limitations defined in the CPU, and each function is assigned with a general-purpose register. By contrast, a GPU defines a plurality of different functions (also called shaders). The various functions are associated with their dedicated accessible resources.

With the development of semiconductor technology, the computing power of mobile devices, such as smartphones, is getting stronger and stronger due to more and more powerful CPUs integrated therein. There is an increasing trend to implement mobile GPUs into mobile devices to boost parallel processing capabilities. Therefore, it is needed to provide techniques for implementing mobile GPU into the mobile devices.

### SUMMARY

A method, device and non-transitory computer-readable medium are disclosed for processing a data workload including related segments of data. A compute shader is enabled with accessibilities to memory space (e.g., a buffer) of an on-chip memory of a processor (e.g., a GPU), such that performance of the processor is improved by utilizing the bandwidth of an on-chip memory (e.g., a buffer) of the processor and saving the bandwidth of an off-chip memory (e.g., a device memory) that is not integrated on a monolithic chip of the processor.

In some instances, a method is provided. The method includes loading a first segment of data to a buffer in an on-chip memory of the processor, receiving a first trigger signal for the first segment of data, instantiating a first compute shader in response to the first trigger signal and loading the first segment of data from the buffer to the first compute shader for execution by the first compute shader. The buffer is used for temporarily storing one or more segments of data of the data workload. The first trigger signal is generated in response to the first segment of data being loaded to the buffer.

In some variations, the trigger signal is generated by circuitry associated with the buffer when the first segment of data is written into the buffer.

In some examples, the method further includes sending information of the first segment of data to the first compute shader. The information of the first segment of data comprises a start address of the first segment of data in the buffer and a size of the first segment of data. The first segment of data in the buffer is located based on the information of the first segment of data.

In some instances, the method further includes closing the first compute shader after the first compute shader completes processing of the first segment of data.

In some variations, the method further includes loading a second segment of data to the buffer, receiving a second trigger signal, instantiating a second compute shader in response to the second trigger signal and loading the second the first trigger signal is generated in response to the first segment of data being loaded to the buffer from the buffer to the second compute shader for execution by the second compute shader. The second trigger signal is generated in response to the second segment of data being loaded to the buffer.

In some examples, the method further includes sending information of the second segment of data to the second compute shader. The information of the second segment of data comprises a start address of the second segment of data in the buffer and a size of the second segment of data. The second segment of data in the buffer is located based on the information of the second segment of data.

In some instances, wherein the number of instantiated compute shaders that run concurrently is less than or equal to a predefined value. The predefined value is determined based on a number of threads included in each segment of data associated with an instantiated compute shader and a preset maximum number of threads that can run concurrently.

In some variations, the method further includes monitoring the buffer, stopping loading additional segments of data to the buffer in response to the buffer reaching a preset capacity. The additional segments of data are segments of the data workload. Memory space allocated in the buffer for storing the first segment of data is released after the processor loads the first segment of data from the buffer to the first compute shader.

In some examples, a device is provided. The device includes one or more processors and a non-transitory computer-readable media storing computer instructions thereon. When the instructions are executed by the one or more processors, causing the one or more processors to further perform the steps of loading a first segment of data to a buffer in an on-chip memory of the processor, receiving a first trigger signal for the first segment of data, instantiating a first compute shader in response to the first trigger signal and loading the first segment of data from the buffer to the first compute shader for execution by the first compute shader. The buffer is used for temporarily storing one or more segments of data of the data workload. The first trigger signal is generated in response to the first segment of data being loaded to the buffer.

In some instances, the trigger signal is generated by circuitry associated with the buffer when the first segment of data is written into the buffer.

In some variations, the one or more processers of the device executes the instructions to perform an additional step of sending information of the first segment of data to the first compute shader. The information of the first segment of data comprises a start address of the first segment of data in the buffer and a size of the first segment of data. The first segment of data in the buffer is located based on the information of the first segment of data.

In some examples, the one or more processers of the device executes the instructions to perform an additional step of closing the first compute shader after the first compute shader completes processing of the first segment of data.

In some instances, the one or more processers of the device executes the instructions to perform additional steps of loading a second segment of data to the buffer, receiving a second trigger signal, instantiating a second compute shader in response to the second trigger signal and loading the second the first trigger signal is generated in response to the first segment of data being loaded to the buffer from the buffer to the second compute shader for execution by the second compute shader. The second trigger signal is generated in response to the second segment of data being loaded to the buffer.

In some variations, the one or more processers of the device executes the instructions to perform an additional step of sending information of the second segment of data to the second compute shader. The information of the second segment of data comprises a start address of the second segment of data in the buffer and a size of the second segment of data. The second segment of data in the buffer is located based on the information of the second segment of data.

In some examples, the number of instantiated compute shaders that run concurrently is less than or equal to a predefined value. The predefined value is determined based on a number of threads included in each segment of data associated with an instantiated compute shader and a preset maximum number of threads that can run concurrently.

In some instances, the one or more processers of the device executes the instructions to perform additional steps of monitoring the buffer, stopping loading additional segments of data to the buffer in response to the buffer reaching a preset capacity. The additional segments of data are segments of the data workload. Memory space allocated in the buffer for storing the first segment of data is released after the processor loads the first segment of data from the buffer to the first compute shader.

In some variations, a non-transitory computer-readable medim is provided. Instructions stored on the non-transitory computer-readable medim, when executed by one or more processors, cause the one or more processors to perform the steps of loading a first segment of data to a buffer in an on-chip memory of the processor, receiving a first trigger signal for the first segment of data, instantiating a first compute shader in response to the first trigger signal and loading the first segment of data from the buffer to the first compute shader for execution by the first compute shader. The buffer is used for temporarily storing one or more segments of data of the data workload. The first trigger signal is generated in response to the first segment of data being loaded to the buffer.

In some examples, the trigger signal is generated by circuitry associated with the buffer when the first segment of data is written into the buffer.

In some instances, the instructions stored on the non-transitory computer-readable medim, when executed by one or more processors, cause the one or more processors to perform an additional step of sending information of the first segment of data to the first compute shader. The information of the first segment of data comprises a start address of the first segment of data in the buffer and a size of the first segment of data. The first segment of data in the buffer is located based on the information of the first segment of data.

In some variations, the instructions stored on the non-transitory computer-readable medim, when executed by one or more processors, cause the one or more processors to perform an additional step of closing the first compute shader after the first compute shader completes processing of the first segment of data.

In some examples, the instructions stored on the non-transitory computer-readable medim, when executed by one or more processors, cause the one or more processors to perform additional steps of loading a second segment of data to the buffer, receiving a second trigger signal, instantiating a second compute shader in response to the second trigger signal and loading the second the first trigger signal is generated in response to the first segment of data being loaded to the buffer from the buffer to the second compute shader for execution by the second compute shader. The second trigger signal is generated in response to the second segment of data being loaded to the buffer.

In some instances, the instructions stored on the non-transitory computer-readable medim, when executed by one or more processors, cause the one or more processors to perform an additional step of sending information of the second segment of data to the second compute shader. The information of the second segment of data comprises a start address of the second segment of data in the buffer and a size of the second segment of data. The second segment of data in the buffer is located based on the information of the second segment of data.

In some variations, the number of instantiated compute shaders that run concurrently is less than or equal to a predefined value. The predefined value is determined based on a number of threads included in each segment of data associated with an instantiated compute shader and a preset maximum number of threads that can run concurrently.

In some examples, the instructions stored on the non-transitory computer-readable medim, when executed by one or more processors, cause the one or more processors to perform additional steps of monitoring the buffer, stopping loading additional segments of data to the buffer in response to the buffer reaching a preset capacity. The additional segments of data are segments of the data workload. Memory space allocated in the buffer for storing the first segment of data is released after the processor loads the first segment of data from the buffer to the first compute shader.

### BRIEF DESCRIPTION OF THE DRAWINGS

FIG. 1A is a block diagram depicting an exemplary computer system.

FIG. 1B is a block diagram depicting an exemplary GPU.

FIG. 1C is a block diagram depicting an exemplary device integrated with a GPU.

FIG. 2 is a block diagram depicting a part of an exemplary rendering pipeline.

FIG. 3A is a block diagram depicting a part of an exemplary tile-based rendering pipeline.

FIG. 3B illustrates an exemplary frame being divided into a plurality of tiles.

FIG. 4 is a block diagram depicting a part of an exemplary rendering pipeline.

FIG. 5 is an exemplary process for processing data utilizing a CS.

FIG. 6 illustrates an exemplary process flow of rendering tile-based data.

FIG. 7 is an exemplary process for executing a step in a rendering pipeline.

### DETAILED DESCRIPTION

The following detailed description is exemplary in nature and is not intended to limit the disclosure or the application and uses of the disclosure. Furthermore, there is no intention to be bound by any expressed or implied theory presented in the preceding background, summary and brief description of the drawings, or the following detailed description.

In the following detailed description, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

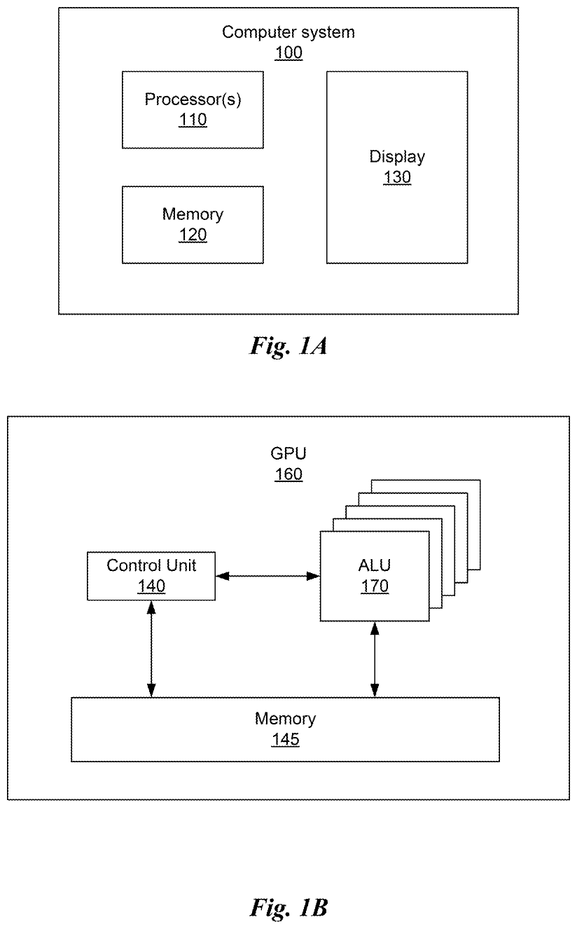

FIG. 1A is a block diagram depicting an exemplary computer system 100 to implement various functions according to one or more examples in the present disclosure. The computer system 100 may be a terminal device such as a desktop computer (e.g., a workstation or a personal computer) or a mobile device (e.g., a smartphone or a laptop), or may be a server communicating with a terminal device. The computer system 100 includes one or more processors 110, a memory 120, and/or a display 130. The processor(s) 110 may include any appropriate type of general-purpose or special-purpose microprocessor (e.g., a CPU or GPU, respectively), digital signal processor, microcontroller, or the like. The memory 120 may be any non-transitory type of mass storage, such as volatile or non-volatile memory, or tangible computer-readable medium including, but not limited to, a read-only memory (ROM), a flash memory, a dynamic random-access memory (RAM), and/or a static RAM. The memory 120 is configured to store computer-readable instructions that, when executed by the processor(s) 110, causes the processor(s) 110 to perform various operations disclosed herein. The display 130 may be integrated as part of the computer system 100 or may be a separate device connected to the computer system 100. The display 130 includes a display device such as a Liquid Crystal Display (LCD), a Light Emitting Diode Display (LED), or any other type of display.

FIG. 1B is a block diagram depicting an exemplary GPU 160 to implement various functions according to one or more examples in the present disclosure. The GPU 160 may be one or more processors 110 included in the computer system 100 as shown in FIG. 1A. The GPU 160 includes one or more control units 140, a plurality of arithmetic logic units (ALU) 170 and a memory 145. The memory 145 is part of the integrated circuit (IC) of the GPU 160 that is fabricated on a monolithic chip, and thus is called an on-chip memory of the GPU 160. Each control unit 140 corresponds to a plurality of ALUs 170. For instance, a control unit 140 decodes instructions from a main memory (e.g., the memory 120 of the computer system 100 as shown in FIG. 1A) into commands and instructs one or more corresponding ALUs 170 to execute the commands. In some examples, the ALUs 170 may store data into the on-chip memory 145. The on-chip memory 145 may include memory space for storing certain types of data. For instance, a buffer may be defined as a region of the on-chip memory 145. The buffer may be used for temporarily storing a number of data segments that are outputs of one or more ALUs 170 when executing commands instructed by the corresponding control unit 140. The control unit 140 may monitor the status of the on-chip memory 145 and determines whether to instruct the corresponding ALUs 170 to stop generating outputs (e.g., data segments) based on the status of the on-chip memory 145. In some variations, the ALUs 170 may store data into a main memory, which is not integrated on the monolithic chip of the GPU 160 and thus is called an off-chip memory. For instance, the main memory may be the memory 120 of the computer system 100.

FIG. 1C is a block diagram depicting an exemplary device 150 integrated with an exemplary GPU 160 to implement various functions according to one or more examples in the present disclosure. The device 150 may include or be part of the computer system 100 as shown in FIG. 1A. The device 150 includes the GPU 160 and the memory 190. The memory 190 is an off-chip memory that is not integrated on the monolithic chip of the GPU 160 and can be accessed by the GPU 160. The memory 190 may be the memory 120 of the computer system 100 as shown in FIG. 1A. The GPU 160 may be one of a plurality of processers (e.g., the processors 110 in the computer system 100 as shown in FIG. 1A) included in the device 150. In some examples, the GPU 160 may be a mobile GPU. When running various functions, the GPU 160 may access the memory 190 of the device 150. For example, the GPU 160 reads data from the memory 190 and/or writes data into the memory 190. In some instances, the GPU 160 includes a plurality of control units 140, a plurality of arithmetic logic units (ALU) 170 and a tile buffer 180 that is included in an on-chip memory of the GPU (e.g., the memory 145 of the GPU 160 as shown in FIG. 1B). Each control unit 140 controls a plurality of ALUs 170. For instance, the control unit 140 instructs the corresponding ALUs 170 to execute commends or stop executing commends. The on-chip memory 145 of the GPU 160 may be defined with one or more buffers for temporarily storing data segments generated by one or more ALUs 170 when executing certain functions. As an example, the tile buffer 180 is memory space defined in the on-chip memory 145 of the GPU 160 for temporarily storing tiles of data that are outputs of one or more ALUs 170 by executing tile-based rendering functions. In a tile-based rendering process, a workload, such as a full image frame, may be subdivided into a plurality of data segments that are called tiles. Each tile may include a number of threads, where a thread is a basic element of the data to be processed. For instance, a thread may be a pixel, and a tile may include a number of pixels/threads. When performing tile-based rendering functions, the one or more ALUs 170 may access the tile buffer 180 to retrieve and/or store data.

When the GPU 160 renders an object (e.g., a visual image), the GPU 160 performs a number of functions following a sequence of steps, which is called a rendering pipeline. At each step, the GPU 160 performs a specialized function called a shader. The GPU 160 renders the object by performing the various functions (e.g., the shaders) following the steps defined in the rendering pipeline, so as to generate a desired final product. For instance, the GPU 160 may render a visual image following a rendering pipeline to generate a desired photorealistic image for displaying.

A GPU defines a plurality of different functions (e.g., the shaders) originally used for shading in graphic scenes. A shader is a type of computer program used for a specialized function. The plurality of shaders defined in the GPU include 2D shaders, such as a pixel shader, and 3D shaders, such as a vertex shader. For example, a pixel shader, also known as fragment shader, computes attributes (e.g., color, depth, etc.) of each fragment and outputs values for each pixel displayed on a screen. A fragment is a collection of values produced by a rasterizer that produces a plurality of primitives from an original image frame. Each fragment represents a sample-sized segment of a rasterized primitive. In some variations, a fragment has a size of one pixel. In another example, a vertex shader computes transformation of each vertex's 3D position in virtual space to a set of 2D coordinates for displaying on a screen, where a primitive uses vertices to reference points. The various shaders are associated with their dedicated accessible resources.

Among these shaders, compute shader (CS) is a relatively flexible one that is capable of performing any calculations (e.g., executing any type of shader) on the GPU thus supporting general-purpose computing on GPU (GPGPU). CS provides memory sharing and thread synchronization features allowing for implementation of more effective parallel programming methods. However, accessibility of CS to resources (e.g., memory storages) is limited by the existing graphic standard like Open Graphic Library (openGL) or Vulkan (which is an application programing interface (API) with focus on 2D and 3D graphics). According to the existing graphic standard, when accessing data output from the other types of shaders, CS can only access data stored in a main memory (e.g., the memory 190) of the device that is an off-chip memory and is not integrated on a monolithic chip of a GPU.

Various examples described in the present disclosure provides techniques to enable accessibility of a CS to memory space (e.g., a buffer) of an on-chip memory of a GPU, such that the GPU performance is improved by utilizing the bandwidth of an on-chip memory (e.g., a tile buffer) of the GPU and saving the bandwidth of an off-chip memory (e.g., a device memory) that is not integrated on a monolithic chip of the GPU. In some examples, a buffer (e.g., a tile buffer) is defined in the on-chip memory of the GPU for temporarily storing one or more data segments (e.g., tiles of data). A dependency relationship is established between the buffer and a CS launcher that instantiates one or more CSs. When a data segment is written into the buffer, circuitry associated with the buffer generates a trigger signal for the data segment. The circuitry associated with the buffer may be a logic IC that is integrated on the on-chip memory and electrically connected to the buffer. The trigger signal is sent to the CS launcher indicating that the data segment (e.g., a tile of data) is loaded into the buffer. After receiving the trigger signal, the CS launcher instantiates a CS (e.g., by calling a dispatch method). Once the data segment is ready in the buffer, the CS retrieves the data segment from the buffer and processes the data segment. The allocated memory space for the data segment in the buffer is released after the data segment is retrieved by the CS. After the CS completes processing of the data segment, the CS is closed. In some variations, capacity of the buffer may be continuously monitored. If the buffer does not exceed a preset capacity, additional data segments may be continuously loaded into the buffer. The circuitry associated with the buffer generates a trigger signal for each data segment written into the buffer. A plurality of trigger signals corresponding to a plurality of data segments are sent to the CS launcher to instantiate a plurality of CSs. The CS launcher instantiates one CS in response to each trigger signal. A maximum number of CSs that can run concurrently may be predefined in the GPU, and/or defined depending on actual implementation. When the GPU determines that the capacity of the buffer exceeds a preset capacity, the GPU may determine to stop loading data segments into the buffer and/or stop executing a preceding step that outputs the data segments.

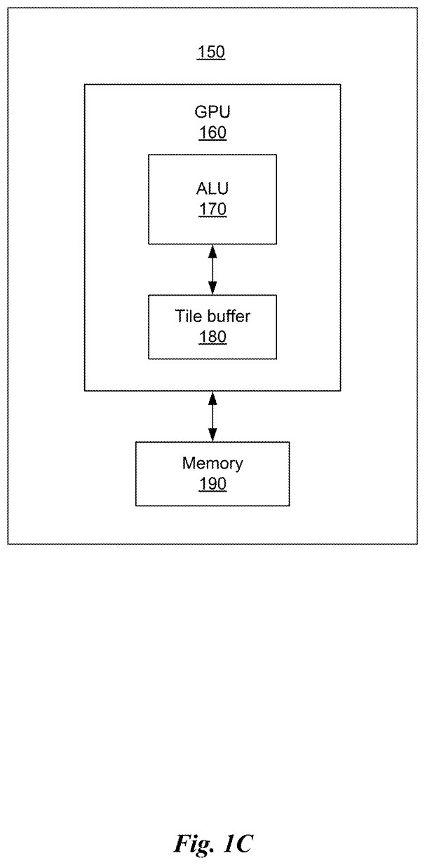

FIG. 2 is a block diagram depicting a part of an exemplary pipeline 200 performed by the computer system 100 and/or the device 150 according to one or more examples in the present disclosure. Job 1 210 is a preceding step in the pipeline 200 that is performed by any one of the shaders defined in the GPU 160. The memory 190 is the memory of the device 150 and is an off-chip memory of the GPU 160. The tile buffer 180 is the memory space defined in the on-chip memory (e.g., the memory 145 as shown in FIG. 1B) of the GPU 160. The tile buffer 180 may be dedicated for temporarily storing data segments that are outputs from the preceding step Job 1 210. Job 2 220 is a succeeding step in the pipeline 200 that processes the output data from the preceding Job 1 210. In this example, the Job 2 220 is performed by a CS. According to the existing graphic standard, a CS is allowed to access outputs of other types of shaders, when the data is stored in an off-chip memory of a GPU. For instance, a preceding Job 1 210 processes data for a full image frame, and outputs the data for the full image frame to the memory 190 of the device 150. Once the data for the full image frame is ready in the memory 190, the succeeding Job 2 220 receives a notification and retrieves the data from the memory 190 for further processing. In this case, the on-chip memory space (e.g., the tile buffer 180) of the GPU 160 is not utilized. A drawback of the pipeline 200 is that the bandwidth of the memory 190 is greatly consumed when transferring data for a full image frame between the GPU and the off-chip memory.

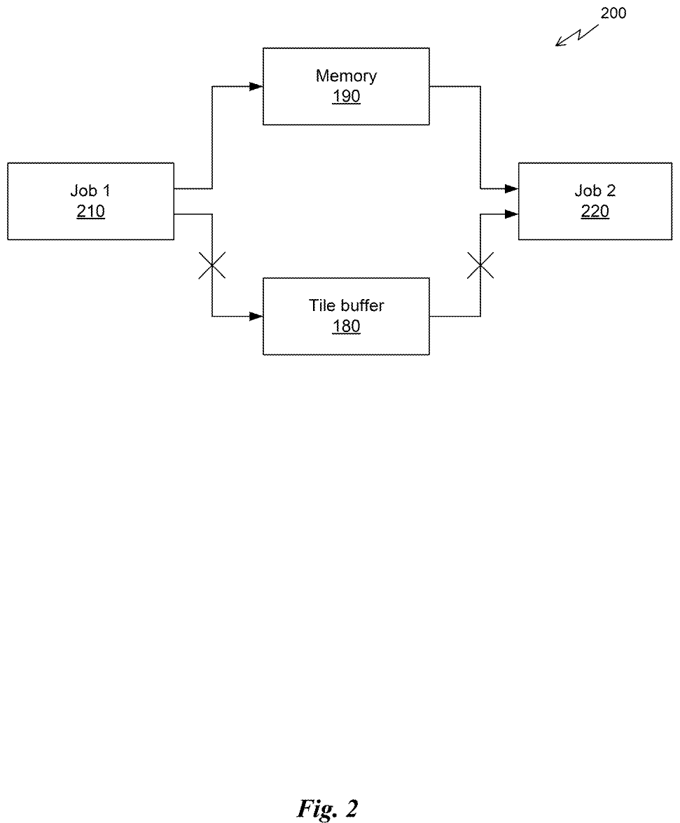

FIG. 3A is a block diagram depicting a part of an exemplary tile-based rendering pipeline 300 performed by the computer system 100 and/or the device 150 according to one or more examples in the present disclosure. A tile-based rendering is a process of dividing a piece of workload into a plurality of segments and rendering the segments separately. For example, a full image frame is divided by a grid and each section of the grid is rendered separately. A section of the grid is a data segment and may be called a tile. Job 1 310 is a preceding job in the pipeline 300 that may be performed by a shader that supports tile-based rendering. For instance, the shader performs the Job 1 310 may be a pixel shader. The memory 190 is the memory of the device 150 and is an off-chip memory of the GPU 160. The tile buffer 180 is the memory space defined in the on-chip memory (e.g., the memory 145) of the GPU 160. The tile buffer 180 may be dedicated for temporarily storing tiles that are outputs from the preceding step Job 1 310. Job 2 320 is a succeeding step in the pipeline 300 that processes the data output from the preceding Job 1 310. In this example, the Job 2 320 may be performed by a shader that also supports tile-based rendering. For example, the Job 2 320 may also be performed by a pixel shader or a different shader that supports tile-based rendering. The shader that performs the preceding Job 1 310 is allowed to access the tile buffer 180 in the GPU 160. So does the shader that performs the succeeding Job 2 320. As such, when the Job 1 310 completes rendering of a tile, the tile is stored in the tile buffer 180. Once the tile is ready in the tile buffer 180, the Job 2 320 is notified and retrieves data from the tile buffer 180 for further processing. In this way, the bandwidth of the memory 190 is greatly saved by utilizing the bandwidth of the on-chip memory of the GPU 160. However, the pipeline 300 is only achievable by using certain shaders currently defined for tile-based rendering according to the existing graphic standard. Among these shaders that support tile-based rendering, pixel shaders are widely used, which render tiles one by one to output attributes per pixel for a full frame that will be displayed on a display screen. By breaking a full image frame into a plurality of tiles may reduce the number of calculations conducted by one pixel shader for an intermediate rendering step. However, the set of input values of a pixel shader and the calculations performed by the pixel shader are well-defined. CSs may provide flexibilities to a tile-based rendering pipeline (e.g., the pipeline 300) if the CSs are implemented into the pipeline. The CS may be configured to perform data exchange and/or synchronization among different threads, so as to improve the performance of the parallel processing. When the CSs are capable of accessing the tile buffer 180 that stores the data generated by other types of shaders executed in the tile-based rendering process, the performance of the GPU 160 when executing the pipeline may be greatly improved.

The present disclosure provides techniques to establish dependency relationship between a buffer (e.g., the tile buffer 180 in the GPU 160) included in an on-chip memory of a GPU and a CS launcher that launchers a CS, such that the CS can directly retrieve data from the buffer, so as to improve the performance of the GPU by utilizing the bandwidth of the on-chip memory of the GPU.

FIG. 3B illustrates an exemplary frame 350 being divided into a plurality of tiles 360 according to one or more examples of the present application. As an example, the full frame 350 may be divided by a 4×4 grid, where each section of the grid is a tile 360. It will be recognized by those skilled in the art that the frame 350 may be a virtual image in 2D or 3D, or may be an analogy to any piece of computing workload that can be subdivided into a plurality of sections. Accordingly, tiles/segments may be sections that are subdivided from any computing workload. A size of a tile/segment may be defined with different values for various applications. For instance, a tile/segment may include data for 16×16 pixels, or 32×32 pixels that are included in the full frame. The tiles/segments may have an identical size or different sizes. Each tile/segment is independent from other tiles/segments, thus suitable for parallel processing.

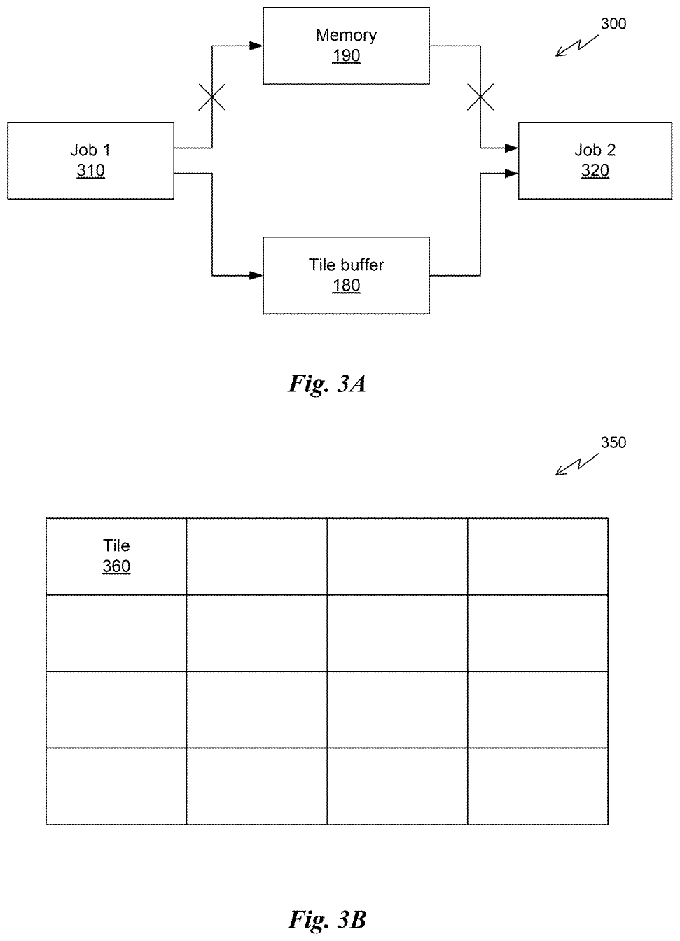

FIG. 4 is a block diagram depicting a part of an exemplary pipeline 400 performed by the computer system 100 and/or the device 150 according to one or more examples in the present disclosure. The pipeline 400 includes tile-based rendering processes. Job 1 410 is a preceding step in the pipeline 300 that is performed by a shader that supports tile-based rendering. For instance, the shader performs the Job 1 410 may be a pixel shader. The memory 190 is the memory of the device 150 and is an off-chip memory of the GPU 160. The tile buffer 180 is the memory space in an on-chip memory of the GPU 160. The tile buffer 180 may be dedicated for temporarily storing data segments that are outputs from the preceding step Job 1 410. Job 2 420 is a succeeding step in the pipeline 400 that processes the data output from the preceding Job 1 410. In this example, the Job 2 420 is performed by a CS. The present disclosure provides techniques to establish data connectivity between the tile buffer 180 and a CS, such that the succeeding Job 2 420 that is performed by a CS can retrieve data from the tile buffer 180 once the data is loaded into the tile buffer 180 from the preceding Job 1 410. In this way, the bandwidth of the memory 190 is saved by utilizing the tile buffer 180 inside the GPU 160.

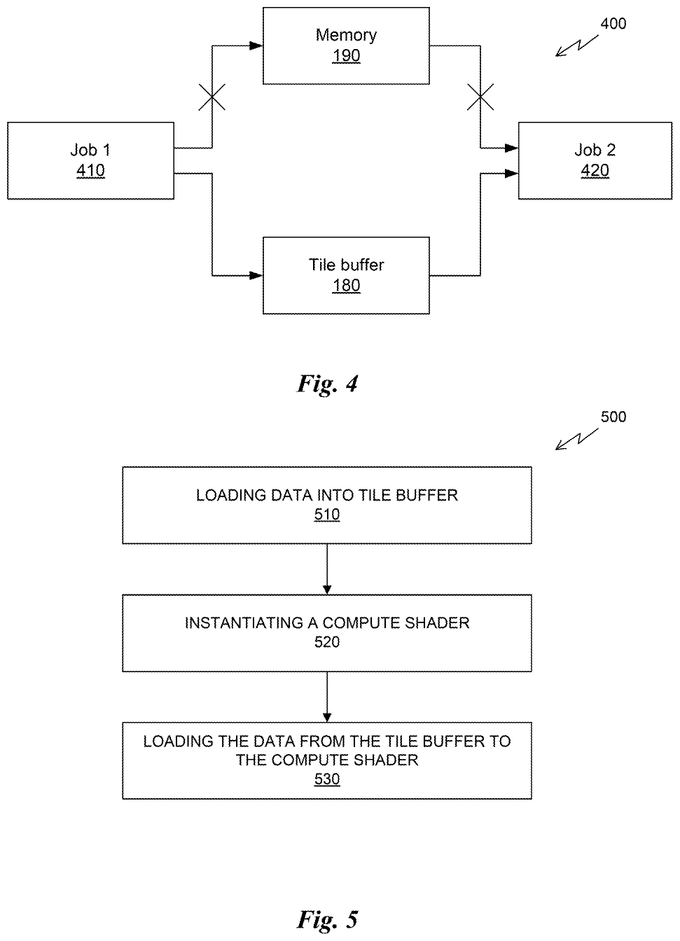

FIG. 5 is an exemplary process 500 for processing data utilizing a CS according to one or more examples in the present disclosure. The process 500 may be performed by the GPU 160 that is integrated as a part of the computer system 100 shown in FIG. 1A, and/or the device 150 shown in FIG. 1B. However, it will be recognized that the process 500 may be performed in any suitable environment and that any of the following blocks may be performed in any suitable order.

In some examples, the process 500 performs a part of the pipeline 400 that includes tile-based rendering processes, as shown in FIG. 4. In some instances, the pipeline 400 is performed to process an image frame (e.g., the frame 350 as shown in FIG. 3B) in a tile-based manner. The image frame is divided into a plurality of tiles (e.g., the tiles 360 of the frame 350). The plurality of tiles may be independent from each other, therefore, may be processed in parallel.

At block 510, the GPU 160 loads data from a preceding step (e.g., the Job 1 410 shown in FIG. 4) into the tile buffer 180. The data includes one or more tiles/segments that are subdivided from a piece of workload. For instance, each tile/segment is associated with a tile 360 that is one of the sections of the frame 350 as shown in FIG. 3B. The data loaded into the tile buffer 180 may be output from one or more ALUs 170 of the GPU that executes a shader to perform the preceding step in the pipeline. The GPU 160 may monitor the tile buffer 180 through one or more control units 140 inside the GPU 160, and determine whether to load additional data into the tile buffer 180 based on the status of the tile buffer 180. The circuitry associated with the tile buffer 180 may generate a trigger whenever a tile is written into the tile buffer 180. The trigger signal may be sent to a CS launcher, and causes the CS launcher to instantiate a CS. The CS launcher may be a program executed by the GPU 160 to instantiate one or more CSs. In some examples, the GPU 160 sends information of the tile that is written into the tile buffer 180 to the CS launcher. The information of the tile includes a start address of the tile stored in the tile buffer 180 and/or the size of the tile (e.g., 4×4 pixels).

At block 520, the GPU 160 instantiates a CS through the CS launcher. The CS launcher when executed by the GPU 160 instantiates a CS in response to a received trigger signal. The CS launcher may instantiate a plurality of CSs in response to a plurality of trigger signals, where each CS is instantiated in response to one trigger signal. The maximum number of CSs that can be instantiated may be predefined in the GPU 160, and/or defined depending on actual implementation. For instance, the GPU 160 may define a workgroup including a number of threads (e.g., 256 threads) that can run concurrently. Each thread may be associated with a pixel included in a piece of workload. A tile may include a number of pixels, for example, 4×4 pixels. As such, 16 CSs may be instantiated and run concurrently when the size of the workgroup is set to be 256 threads. A workgroup may be defined as one-dimensional (1D), two-dimensional (2D) or three-dimensional (3D) space. Accordingly, the size of a CS may be defined in 1D, 2D or 3D. The size of the CS may be associated with the size of a tile that is processed by the CS.

At block 530, the GPU 160 loads the data from the tile buffer 180 to the CS. Once a tile is ready in the tile buffer 180, the instantiated CS may retrieve the tile from the tile buffer 180. In some instances, the CS obtains the tile from the tile buffer 180 based on the information of the tile, which may include the start address of the tile and/or the size of the tile.

After the CS retrieves the tile from the tile buffer 180, the memory space allocated in the tile buffer 180 for storing the tile may be released. Once the CS completes processing of the tile, the CS is closed.

In some variations, the GPU 160 continuously loads tiles from a preceding step into the tile buffer 180, as long as the tile buffer 180 does not reach a preset capacity. The preset capacity may be a maximum capacity of the tile buffer 180. Whenever a tile is ready in the tile buffer 180, the GPU 160 may instantiate a CS through the CS launcher and the CS may read the tile from the tile buffer 180. When a plurality of the tiles are ready in the tile buffer 180, the GPU 160 may instantiate a plurality of CSs through the CS launcher one by one, and each CS reads a tile from the tile buffer 180. In some variations, the GPU 160 may execute instructions to query execution time of one or more CSs and determine whether to stop loading data into the tile buffer 180 based on the results of the query. If the execution time of one or more CSs is beyond a preset time limit, the GPU may determine to stop loading additional tiles from the preceding step and/or to stop the preceding step. In some instances, the GPU 160 continuously monitors the capacity of the tile buffer 180. If the GPU 160 determines the tile buffer 180 reaches the preset capacity, the GPU 160 may determine to stop loading additional tiles from the preceding step and/or to stop the preceding step.

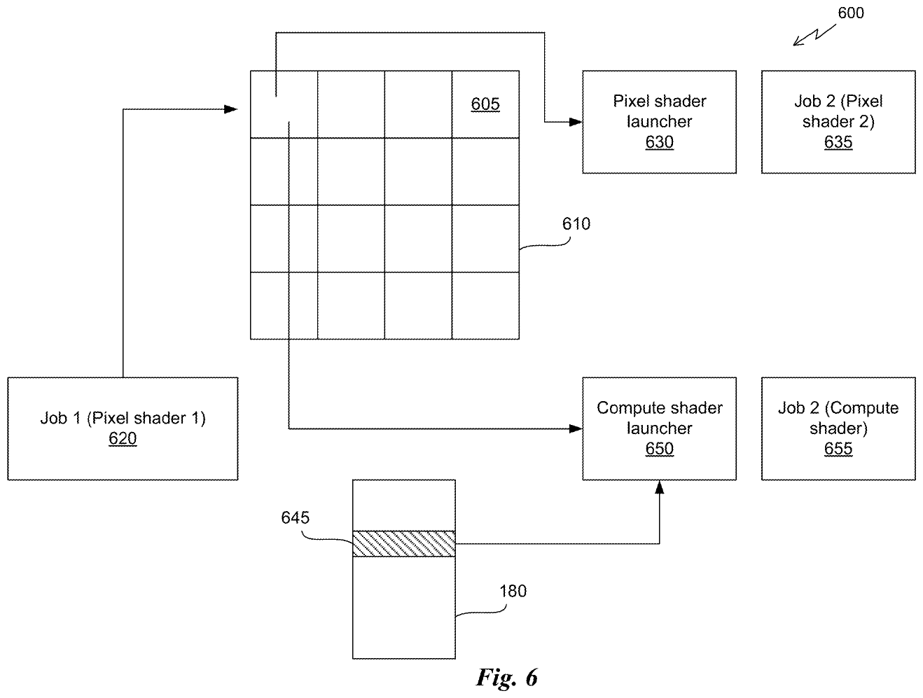

FIG. 6 illustrates an exemplary process flow 600 of rendering tile-based data according to one or more examples of the present disclosure. The process flow 600 may be performed by the GPU 160 that is integrated as a part of the computer system 100 shown in FIG. 1A, and/or the device 150 shown in FIG. 1B. A full frame 610 is divided into a plurality of tiles 605, for example by a 4×4 grid, and the plurality of tiles 605 may be processed one by one in the process flow 600. Each tile may include a number of pixels of the frame 610, such as 4×4 pixels. A preceding Job 1 620 may be performed by a first pixel shader (pixel shader 1). Once the Job 1 completes the step of rendering a tile 605 by using the pixel shader 1, the GPU 160 loads the output of the Job 1 620 into the tile buffer 180. The tile buffer 180 is defined in the on-chip memory of the GPU 160 and dedicated for temporarily storing data segments (e.g., the tiles 605) that are outputs from the preceding step Job 1 610. Memory space 645 may be allocated for storing the tile 605 in the tile buffer 180. Information of the tile 605 may be generated and is used for locating the memory space 645 in the tile buffer 180 that stores the tile 605. The information of the tile 605 may include a start address of the tile 605 in the tile buffer 180 and/or the size of the tile 605.

In some examples, a succeeding Job 2 635 is performed by a second pixel shader (pixel shader 2). Once the memory space 645 is loaded with the tile 605, the GPU 160 instantiates the pixel shader 2 through a pixel shader launcher 630. A pixel shader launcher 630 is a program executed by the GPU 160 to instantiate one or more pixel shaders. The pixel shader 2 reads the tile 605 stored in the memory space 645 of the tile buffer 180 and perform computations defined in the Job 2 635. Once the pixel shader 2 completes the processing of the tile 605, the pixel shader 2 is closed. The GPU 160 may continuously load tiles 605 from the preceding Job 1 620 to the tile buffer 180. Whenever a tile 605 is ready in the tile buffer 180, the GPU 160 may instantiate a pixel shader through the pixel shader launcher 630 to perform computations defined in the Job 2 635.

In some instances, a succeeding Job 2 655 is performed by a CS. The GPU 160 sends a trigger signal to a CS launcher 650 to instruct the CS launcher 650 to instantiate a CS for the Job 2 655. In some variations, the GPU 160 sends the information of the tile 605 to the CS launcher 650. The information of the tile 605 may be sent before or after the trigger signal is sent to the CS launcher. Once the memory space 645 is loaded with the tile 605, the GPU 160 instantiates a CS through the CS launcher 650. The CS reads the tile 605 stored in the memory space 645 of the tile buffer 180 and performs the computations defined in the Job 2 655. Once the CS completes the computing of the tile 605, the CS is closed.

In some examples, the GPU 160 may continuously load tiles 605 from the preceding Job 1 620 to the tile buffer 180. Whenever a tile 605 is ready in the tile buffer 180, the GPU 160 may instantiate a CS through the CS launcher 650 to perform computations defined in the Job 2 655. The CS launcher 650 may instantiate a plurality of CSs in response to a plurality of trigger signals, where each CS is instantiated in response to one trigger signal. A maximum number of CSs that can run concurrently may be predefined in the GPU, and/or defined depending on actual implementation. For instance, the GPU 160 may define a workgroup including a number of threads (e.g., 256 threads) that can run concurrently. Each thread may be associated with a pixel included in the frame 610. A tile 605 may include a number of pixels, for example, 4×4 pixels. As such, 16 CSs may be instantiated and run concurrently when the size of the workgroup is set to be 256 threads. A workgroup may be defined as one-dimensional (1D), two-dimensional (2D) or three-dimensional (3D) space. Accordingly, the size of a CS may be defined in 1D, 2D or 3D. The size of the CS may be associated with the size of a tile that is processed by the CS.

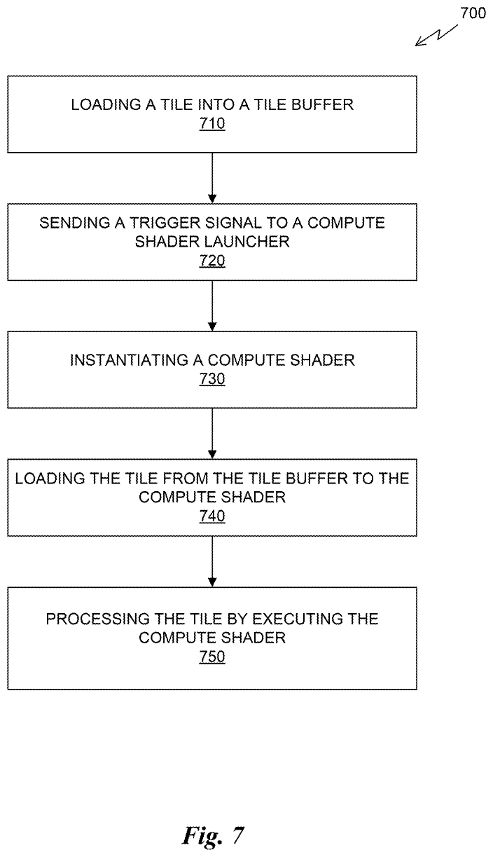

FIG. 7 is an exemplary process 700 for executing a step in a rendering pipeline according to one or more examples in the present disclosure. The process 700 may be performed by the GPU 160 that is integrated as a part of the computer system 100 shown in FIG. 1A, and/or the device 150 shown in FIG. 1B. However, it will be recognized that the process 700 may be performed in any suitable environment and that any of the following blocks may be performed in any suitable order. The pipeline may include tile-based processing steps, referring back to FIG. 6 for exemplary tiles (e.g., the tiles 605) that will be described in the process 700. The rendering pipeline may include a plurality of steps of performing rendering to an object (e.g., a virtual scene). In some examples, the GPU 160 executes the rendering pipeline of an input image to generate a photorealistic image and causes displaying of the photorealistic image on a display (e.g., the display 130 of the computer system 100).

At block 710, the GPU 160 loads a tile 605 into the tile buffer 180 of the GPU 160. The tile 605 may be an output from a preceding step in the rendering pipeline. The size of the tile 605 may be defined by a user while defining the rendering pipeline. The tile 605 stored in the tile buffer 180 may be located based on information of the tile 605. The information of the tile 605 may include a start address of the tile 605 in the tile buffer 180 and/or a size of the tile 605.

At block 720, the GPU 160 sends a trigger signal to a CS launcher. The trigger signal is generated by the circuitry associated with the tile buffer 180 when the tile 605 is written into the tile buffer 180. The trigger signal may be generated at the beginning, in the middle or at the end of the process of writing the tile 605 into the tile buffer 180. The trigger signal is sent to the CS launcher after being generated. The GPU 160 monitors the tile buffer 180 and determines whether the tile buffer 180 reaches a preset capacity (e.g., a maximum capacity of the tile buffer 180). If the tile buffer 180 does not reach the preset capacity, the GPU 160 continuously loads tiles 605 from the preceding step. A trigger signal is generated for each tile 605 loaded into the tile buffer 180. As such, the GPU 160 sends a plurality of trigger signals to the CS launcher whenever a trigger signal is generated. The CS launcher is instructed to instantiate a plurality of CSs in response to the plurality of trigger signals, and each CS is instantiated for a respective trigger signal to process a respective tile 605 in the tile buffer 180. If the tile buffer 180 reaches the preset capacity, the GPU 160 may determine to stop loading tiles from the preceding step and/or stop the execution of the preceding step. In some instances, the GPU 160 sends the tile information of the tiles 605 to the CS launcher. The tile information may be sent before or after the trigger signals are sent to the CS launcher.

At block 730, the GPU 160 instantiates a CS through the CS launcher. Once the tile 605 is ready in the tile buffer 180, the CS launcher instantiates a CS to perform computations defined in a succeeding step in the rendering pipeline. When a plurality of tiles 605 are loaded into the tile buffer 180, the CS launcher instantiates a plurality of CSs one by one, where each CS processes a respective tile 605.

A maximum number of CSs that can run concurrently may be predefined in the GPU, and/or defined depending on actual implementation. For instance, the GPU 160 may define a workgroup including a number of threads (e.g., 256 threads) that can run concurrently. Each thread may be associated with a pixel included in the frame 610. A tile 605 may include a number of pixels, for example, 4×4 pixels. As such, 16 CSs may be instantiated and run concurrently when the size of the workgroup is set to be 256 threads. A workgroup may be defined as one-dimensional (1D), two-dimensional (2D) or three-dimensional (3D) space. Accordingly, the size of a CS may be defined in 1D, 2D or 3D. The size of the CS may be associated with the size of a tile 605 that is processed by the CS.

At block 740, the GPU 160 loads the tile 605 from the tile buffer 180 to the CS. Once the tile 605 is ready in the tile buffer 180, the CS retrieves the tile 605 from the tile buffer 180 and processes the tile 605. The CS may locate the tile 605 stored in the tile buffer 180 based on the tile information, which may include the start address of the tile 605 in the tile buffer 180 and/or the size of the tile 605. Memory space allocated for the tile 605 in the tile buffer 180 may be released after the CS retrieves the tile 605 from the tile buffer.

At block 750, the GPU 160 processes the tile 605 by executing the CS. After the CS completes processing of the tile 605, the CS is closed by the GPU 160 through the CS launcher. In some examples, the GPU 160 may execute instructions to query an execution time of one or more CSs that are instantiated to process the tiles 605. The GPU 160 may determine whether to stop loading tiles 605 from the preceding step and/or stop the execution of the preceding step based on the results of the query.

In some variations, the GPU 160 further causes display of an image based on one or more tiles 605 that are processed and output from a step performed by the CSs in the rendering pipeline. In some examples, the GPU 160 may cause display of the one or more tiles 605 one by one whenever a tile 605 is output from a CS. In some instances, the GPU 160 may cause display of the tiles 605 that are synchronized in a step performed by the CSs.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

What is claimed is:

1. A method for processing a data workload comprising related segments of data, the method comprising:
loading, by a processor, a first segment of data to a buffer in an on-chip memory of the processor, wherein the buffer is used for temporarily storing one or more segments of the data workload;
receiving, by the processor, a first trigger signal for the first segment of data, wherein the first trigger signal is generated in response to the first segment of data being loaded to the buffer;
instantiating, by the processor, a first compute shader in response to the first trigger signal; and
loading, by the processor, the first segment of data from the buffer to the first compute shader for execution by the first compute shader.

2. The method of claim 1, wherein the first trigger signal is generated by circuitry associated with the buffer when the first segment of data is loaded into the buffer.

3. The method of claim 1, further comprising:
sending, by the processor, information of the first segment of data to the first compute shader,
wherein the information of the first segment of data comprises a start address of the first segment of data in the buffer and a size of the first segment of data, and
wherein the first segment of data in the buffer is located based on the information of the first segment of data.

4. The method of claim 1, further comprising:
closing, by the processor, the first compute shader after the first compute shader completes processing of the first segment of data.

5. The method of claim 1, further comprising:
loading, by the processor, a second segment of data to the buffer, wherein the second segment of data is a segment of the data workload;
receiving, by the processor, a second trigger signal, wherein the second trigger signal is generated in response to the second segment of data being loaded to the buffer;
instantiating, by the processor, a second compute shader in response to the second trigger signal; and
loading, by the processor, the second segment of data from the buffer to the second compute shader for execution by the second compute shader.

6. The method of claim 5, further comprising:
sending, by the processor, information of the second segment of data to the second compute shader,
wherein the information of the second segment of data comprises a start address of the second segment of data in the buffer and a size of the second segment of data, and
wherein the second segment of data in the buffer is located based on the information of the second segment of data.

7. The method of claim 5, wherein the number of instantiated compute shaders that run concurrently is less than or equal to a predefined value, and wherein the predefined value is determined based on a number of threads included in each segment of data associated with an instantiated compute shader and a preset maximum number of threads that can run concurrently.

8. The method of claim 1, further comprising:
monitoring, by the processor, the buffer; and
in response to the buffer reaching a preset capacity, stopping, by the processor, loading additional segments of data to the buffer,
wherein the additional segments of data are segments of the data workload, and
wherein memory space allocated in the buffer for storing the first segment of data is released after the processor loads the first segment of data from the buffer to the first compute shader.

9. A device for processing a data workload comprising related segments of data, the device comprising:
one or more processors; and
a non-transitory computer-readable media storing computer instructions thereon, when executed by the one or more processors, causing the one or more processors to perform the steps of:
loading a first segment of data to a buffer in an on-chip memory of the processor, wherein the buffer is used for temporarily storing one or more segments of the data workload;
receiving a first trigger signal for the first segment of data, wherein the first trigger signal is generated in response to the first segment of data being loaded to the buffer;
instantiating a first compute shader in response to the first trigger signal; and
loading the first segment of data from the buffer to the first compute shader for execution by the first compute shader.

10. The device of claim 9, wherein the first trigger signal is generated by circuitry associated with the buffer when the first segment of data is loaded into the buffer.

11. The device of claim 9, wherein the instructions, when executed by the one or more processors, cause the one or more processors to further perform the step of:
sending information of the first segment of data to the first compute shader,
wherein the information of the first segment of data comprises a start address of the first segment of data in the buffer and a size of the first segment of data, and
wherein the first segment of data in the buffer is located based on the information of the first segment of data.

12. The device of claim 9, wherein the instructions, when executed by the one or more processors, cause the one or more processors to further perform the step of:
closing the first compute shader after the first compute shader completes processing of the first segment of data.

13. The device of claim 9, wherein the instructions, when executed by the one or more processors, cause the one or more processors to further perform the steps of:
loading a second segment of data to the buffer, wherein the second segment of data is a segment of the data workload;
receiving a second trigger signal, wherein the second trigger signal is generated in response to the second segment of data being loaded to the buffer;
instantiating a second compute shader in response to the second trigger signal; and
loading the second segment of data from the buffer to the second compute shader for execution by the second compute shader.

14. The device of claim 13, wherein the instructions, when executed by the one or more processors, cause the one or more processors to further perform the step of:
sending information of the second segment of data to the second compute shader,
wherein the information of the second segment of data comprises a start address of the second segment of data in the buffer and a size of the second segment of data, and
wherein the second segment of data in the buffer is located based on the information of the second segment of data.

15. The device of claim 13, wherein the number of instantiated compute shaders that run concurrently is less than or equal to a predefined value, and wherein the predefined value is determined based on a number of threads included in each segment of data associated with an instantiated compute shader and a preset maximum number of threads that can run concurrently.

16. The device of claim 9, wherein the instructions, when executed by the one or more processors, cause the one or more processors to further perform the steps of:
monitoring the buffer; and
in response to the buffer reaching a preset capacity, stopping loading additional segments of data to the buffer,
wherein the additional segments of data are segments of the data workload, and
wherein memory space allocated in the buffer for storing the first segment of data is released after the processor loads the first segment of data from the buffer to the first compute shader.

17. A non-transitory computer-readable media storing computer instructions for displaying an image that, when executed by one or more processors, cause the one or more processors to perform the steps of:
loading a first segment of data to a buffer in an on-chip memory of the processor, wherein the buffer is used for temporarily storing one or more segments of the data workload;
receiving a first trigger signal for the first segment of data, wherein the first trigger signal is generated in response to the first segment of data being loaded to the buffer;
instantiating a first compute shader in response to the first trigger signal; and
loading the first segment of data from the buffer to the first compute shader for execution by the first compute shader.

18. The non-transitory computer-readable media of claim 17, wherein the instructions, when executed by the one or more processors, cause the one or more processors to further perform the step of:
sending information of the first segment of data to the first compute shader,
wherein the information of the first segment of data comprises a start address of the first segment of data in the buffer and a size of the first segment of data, and
wherein the first segment of data in the buffer is located based on the information of the first segment of data.

19. The non-transitory computer-readable media of claim 17, wherein the instructions, when executed by the one or more processors, cause the one or more processors to further perform the steps of:
loading a second segment of data to the buffer, wherein the second segment of data is a segment of the data workload;
receiving a second trigger signal, wherein the second trigger signal is generated in response to the second segment of data being loaded to the buffer;
instantiating a second compute shader in response to the second trigger signal; and
loading the second segment of data from the buffer to the second compute shader for execution by the second compute shader.

20. The non-transitory computer-readable media of claim 17, wherein the instructions, when executed by the one or more processors, cause the one or more processors to further perform the steps of:
monitoring the buffer; and
in response to the buffer reaching a preset capacity, stopping loading additional segments of data to the buffer,
wherein the additional segments of data are segments of the data workload, and
wherein memory space allocated in the buffer for storing the first segment of data is released after the processor loads the first segment of data from the buffer to the first compute shader.
